(19) United States
(12) Patent Application Publication
(10) Pub. No.: US 2026/0137592 A1
(43) Pub. Date: May 21, 2026

(54) MODULAR AESTHETIC-TREATMENT TRAY BASE WITH ASSOCIATED MODULES AND COMPONENTS

(71) Applicant: KA DESIGNS LLC, The Colony, TX (US)

(72) Inventor: David E. KING, The Colony, TX (US)

(73) Assignee: KA DESIGNS LLC, The Colony, TX (US)

(21) Appl. No.: 19/389,343

(22) Filed: Nov. 14, 2025

Related U.S. Application Data
(60) Provisional application No. 63/721,941, filed on Nov. 18, 2024.

(51) Int. Cl. A61J 1/16

(52) U.S. Cl. CPC A61J 1/16

(57) ABSTRACT

A universal vial holder aperture including a cylindrical body with an inner and outer wall where an inner area is defined by a perimeter formed by the inner wall of the cylindrical body and a plurality of flexible fins where the plurality of flexible fins extends from the inner wall of the cylindrical body into the inner area. The universal vial holder aperture can be positioned in a vial holder base body having a generally planar upper surface, surrounding perimeter walls, and a cylindrical cavity to receive the universal vial holder aperture. The vial holder base body can be positioned in a treatment tray base along with a large module. The treatment tray base can also include a disposable tray insert which includes an open cell gyroid matrix foam and an open compartment adapted to receive waste items.

### BACKGROUND

There is a need in the field of plastic surgery for a device which enables safe and efficient multi-injection procedures. For example, cosmetic procedures that use injectable substances like dermal fillers and neurotoxins to reduce wrinkles, add volume, and enhance facial contours. Specific examples include botulinum toxin, hyaluronic acid fillers, calcium hydroxyapatite fillers, and fat injections.

The embodiments described below fulfill this need and provide unexpected advantages such as allowing for one handed use which increases both safety and efficiency.

### SUMMARY OF THE INVENTION

The disclosure here is directed to various modules of a modular aesthetic-treatment tray base and to the modular aesthetic-treatment tray base as a whole. The modular aesthetic-treatment tray base may include various combinations of the following modules:

Treatment Tray Base,

Universal Vial Holder assembly including a Small Module iteration,

Capped Needle Holder including a Large Module iteration,

Consumable Waste Tray with Open Cell Matrix Sponge, and

Open Cell Matrix Sponge.

The present disclosure is directed embodiments which include a universal vial holder aperture including:

a cylindrical body with an inner and outer wall wherein an inner area is defined by a

perimeter formed by the inner wall of the cylindrical body and

a plurality of flexible fins,

wherein the plurality of flexible fins extends from the inner wall of the cylindrical body into the inner area.

In some embodiments, the plurality of flexible fins comprises from 4 to 12 fins.

In some embodiments, the plurality of flexible fins are uniformly canted in the same rotational direction.

In some embodiments, the plurality of flexible fins are shaped to form a cone of negative space positioned at at least one end of the cylindrical body.

Some embodiments additionally include a vial holder base body, the vial holder base body includes a generally planar upper surface, surrounding perimeter walls, and a cylindrical cavity, wherein said cylindrical cavity receives said universal vial holder aperture.

Some embodiments additionally include a treatment tray base,

where said treatment tray base includes a small module compartment, a large module

compartment, and at least one protruding portion positioned between said small module

compartment, a large module compartment,

where the small module compartment and a large module compartment are physically

separated by the at least one protruding portion of the treatment tray base, and

where the treatment tray base receives the vial holder base body in the small module

compartment.

Some embodiments additionally include a large module where the large module includes at least one area for receiving at least one flexible holder insert and where the treatment tray base receives the large module in the large module compartment.

In some embodiments, the flexible holder insert includes, a cylindrical body having a top portion and a bottom portion and having an inner and outer wall wherein an inner area is defined by a perimeter formed by the inner wall of the cylindrical body, and

a plurality of flexible fins where the plurality of flexible fins extends from the inner wall of the cylindrical body into the inner area.

In some embodiments, the plurality of flexible fins of the flexible holder insert comprises from 6 to 18 fins.

In some embodiments, the plurality of flexible fins of the flexible holder insert are straight and are canted to form a gentle corkscrew profile.

In some embodiments, the plurality of flexible fins are shaped to form a cone of negative space positioned at at least one end of the cylindrical body.

In some embodiments, the plurality of flexible fins of the flexible holder insert have a top portion and a bottom portion wherein the top portion of the plurality of flexible fins slant toward the bottom portion of the cylindrical body of the flexible holder insert collectively forming a frustoconical structure.

In some embodiments, the large module comprises a plurality of areas for receiving a flexible holder insert.

In some embodiments, the large module comprises a plurality of areas for receiving a capped needle.

Some embodiments additionally include an undermining cavity extending laterally along the bottom of the cylindrical cavity wherein the undermining cavity is adapted to receive one or more segmented weights.

In some embodiments, the segmented weights comprise a plurality of weights and at least one adhesive backing.

In some embodiments, the weights are positioned at the bottom of the undermining cavity and the at least one adhesive backing is positioned above the weights in the cavity.

In some embodiments, a cover plate is positioned above the at least one adhesive backing in the cavity and separates the segmented weights from the vial holder aperture.

In some embodiments, the treatment tray base additionally includes a disposable tray insert, where the disposable tray insert includes an open cell gyroid matrix foam and an open compartment adapted to receive waste items.

The present disclosure may include any one or more of the individual features disclosed above and/or below alone or in any combination thereof.

These and other features of the present invention can be best understood from the following description and drawings.

The small module portion, represented by the base body in the figures, includes an area that can receive various small modules and large module portion includes an area that can receive various large modules. The small module portion and a large module portion have physically defined boarders which separate received small and large modules from each other. The small module portion and a large module portion are also physically connected to each other. For example, the small module portion and a large module portion may share a common base.

The universal vial holder can be in the form of a small module for a large module. The universal vial holder has a generally cylindrical shape with fins extending inward from the perimeter of the cylinder toward the center of the cylinder. These fins are generally the same length and extend at a non-ninety-degree angle from the perimeter. For example, the fins may form an acute and obtuse an angle with the inner wall of the universal vial holder. The fins may lean in a clockwise or counter-clockwise direction. In the preferred embodiment all fins lean in the same clockwise or counter-clockwise direction. The fins are made from a material that is flexible and durable, for example, a thermoplastic polyurethane (TPU) with a shore hardness of 95A. Such a material allows the interior fins to flex, accommodating a wide range of standard vial sizes. In an example iteration depicted the universal vial holder is sized to accommodate the vial sizes that are most commonly used for neurotoxin products, for example, Botulinum Toxin.

The TPU’s flexibility enables the holder’s "Universal" functionality. When a vial is inserted at, for example, a 45-degree angle and rotated clockwise, the flexible fins displace outward, creating a secure friction fit around the vial’s perimeter. The resistance force exerted by the fins, as well as the friction of the material on the vial's surface, ensures a snug fit. The friction is strong enough to completely invert the device at the vial will hold in place. In some embodiments, there are from 4 to 12 fins or 4 to 10 fins or 4 to 8 fins or 6 to 10 fins or 6 to eight fins, for example, 4, 5, 6, 7, 8, 9, 10, 11, or 12 fins. This is applicable to a variety of vial diameters relative to the total diameter of the universal vial holder, for example, diameters that are 20-80%, 25-75%, 33-66%, 40-60%, or 45-55% of the diameter of the universal vial holder.

Additionally, upon vial removal, the TPU material returns to its default shape, maintaining its form as pictured, ready for repeated use. That is, the universal vial holder can accommodate repeated uses by vials having different diameters.

In some embodiments, the fins operate with an aperture-like mechanism, that is they operate similarly to a camera lens aperture, adjusting as the vial is pressed into the holder's center. The user does not manually adjust the fins; they flex upon vial insertion and return to their “home” position upon removal of the vial. The universal vial holder can alternatively be adapted into a large module which can fit into the large module portion of the treatment tray base.

The universal vial holder fits into this small module base to enable full functionality of the universal vial holder. The small module base features 4 recesses on the bottom corners to attach anti-skid feet to the module to prevent slipping on the user's work surface. In addition, the module has 1 ounce of weight encapsulated in its base. The combination of the universal vial holder, anti-skid feet, and added weight provide a secure station for the user's vial. This prevents tipping the vial over or pushing/sliding it off of a work surface. This module can be used independently or utilized with the Treatment tray base when placed in the treatment tray base's small module compartment.

The small module base may include four anti-skid feet, a wide footprint, and an encapsulated weight, for example, 0.5oz to 5oz, for example 1 oz, 2oz, 3oz, or 4oz, ensuring added stability during use. These features reduce the risk of tipping or shifting, even with frequent interactions.

The small module base may be fully functional as a standalone unit, allowing injectors to use it independently of the treatment tray base. Its compact design and stability features make it a practical, portable option for various work environments. The base design allows for flexibility and can be tailored to accommodate various components, such as multiple capped needle holders or other injector-specific tools. With ample area available, the module is designed to meet existing needs while remaining adaptable for future requirements and unforeseen innovations. When used with the treatment tray base, this small module enhances workflow efficiency and supports a wide variety of injector procedures that require a vial of product on-hand or for preparation prior to a procedure.

In some embodiments, the capped needle holder has a generally cylindrical shape with fins extending inward from the perimeter of the cylinder toward the center of the cylinder. These fins are generally the same length and extend at a non-ninety-degree angle from the perimeter. In some embodiments, the fins may also slope away from the top of the cylinder as depicted. This shape creates a funnel which can direct a capped needle toward the center of the cylinder when being inserted.

The fins may be made from a material that is flexible and durable, for example, a thermoplastic polyurethane (TPU) with a shore hardness of 95A. Such a material allows the interior fins to flex, accommodating a wide range of standard capped needles. The concept of the capped needle holder is similar to the universal vial holder however specifically applied to capped needles. The structure is more suitable for holding capped needles attached to syringes and offers semi-universal compatibility with various cap sizes due to the uniform dimensions of capped needles. Some embodiments of the capped needle holder include a slight corkscrew orientation of the "fins" to maximize surface area.

In some embodiments, the capped needle holder functions similarly to the pincer grasp of the thumb and forefinger, providing just enough resistance to securely hold a capped needle. Upon insertion, the aperture of the capped needle holder flexes slightly, “squeezing” the cap with controlled pressure. This allows users the ability to uncap needles attached to syringes while keeping the cap firmly in place.

The holder keeps the cap oriented vertically, enabling safe, convenient recapping and helping reduce the risk of needle stick injuries. It also provides upright storage for syringes, saving valuable workstation space, especially for syringes ranging from, for example, 6 to 11 inches in length.

The capped needle holder also aids in securing the needle to the syringe. When the user applies downward pressure and turns the syringe clockwise, the holder’s grip resists, allowing the user to tighten the needle. Conversely, turning counterclockwise loosens the grip, enabling easy removal of the capped needle from the holder.

The large module may integrate seamlessly into the large module compartment of the treatment tray base. The depicted large module is designed to accommodate multiple uncapped needle holder components while offering additional features such as spare eight spare needle compartments shown around the perimeter.

The large module base may include six anti-skid feet, a wide footprint, and an encapsulated, weight for example a weight from 0.5-5oz, for example 2oz to provide added stability during use. These features reduce the risk of tipping or shifting, even with frequent interactions.

When used with the treatment tray base, this large module enhances workflow efficiency and supports a wide variety of injector procedures that require a multiple dermal filler products and a variety of needle sizes to be accessible on-hand or for preparation.

The large module base may alternatively be used as a standalone unit, allowing injectors to use it independently of the treatment tray base. Its compact design and stability features make it a practical, portable option for various work environments. The large module base design allows for flexibility and can be tailored to accommodate various components, such as multiple capped needle holders or other injector-specific needs. With ample free area the module is designed to meet existing needs while remaining adaptable for future requirements and unforeseen innovations.

In an alternative embodiment of a large module, the large module includes waste tray which is a single-use consumable designed for safe and efficient disposal of contaminated supplies and general waste during aesthetic procedures. This waste tray fits securely into the large module compartment of the treatment tray base, it can also be used independently as a standalone waste solution.

In some embodiments, the large module waste tray intended to be disposed of after a single use, the large module waste tray is a convenient, hygienic solution for managing procedure-related waste efficiently. While designed to fit within the large module section of the treatment tray base, the waste tray can also be used independently, offering flexible setup options based.

The large module waste tray may include a specific portion that is specifically shaped to receive an open cell matrix sponge and a separated portion to receive other waste products. This separated portion to receive other waste products may be referred to as a contaminated supplies area which is an open section of the tray is designated for placing other contaminated supplies and general waste, keeping the injector’s workspace organized and minimizing cross-contamination.

The large module waste tray may also include an open cell matrix sponge. This open cell matrix “sponge” provides a secure surface for dirty needles, allowing them to be safely embedded until disposal, reducing the risk of accidental needle sticks.

The open cell matrix sponge is a specialized component designed to securely hold dirty needles after use. It may be constructed from compressible and flexible material, for example, thermoplastic polyurethane (TPU). This open cell matrix sponge may be engineered to support the weight of an empty syringe attached to the needle, keeping it securely in place when fully depressed into the matrix. The sponge provides an advantageous balance of compressibility and flexibility, enabling needles to be inserted with minimal effort while maintaining a stable hold. The open cell structure of the sponge allows dirty needles to be inserted and securely held, preventing movement or dislodgement, even with the weight of an attached empty syringe. The custom shape of the sponge is tailored for a snug, friction fit within the sponge section of the disposable tray, ensuring it remains securely in place during use.

### BRIEF DESCRIPTION OF THE DRAWINGS

FIG. 1 illustrates a top perspective view of a treatment tray base.

FIG. 2 illustrates a bottom perspective view of a treatment tray base.

FIG. 3 illustrates a top perspective view of a small module universal vial holder assembly.

FIG. 4 illustrates a bottom perspective view of a small module universal vial holder assembly.

FIG. 5 illustrates a top perspective exploded view of a small module universal vial holder assembly.

FIG. 6 illustrates a cross-section view of a small module universal vial holder assembly along line A-A.

FIG. 7 illustrates a top perspective view of a large module body shown as a capped needle holder.

FIG. 8 illustrates a bottom perspective view of a large module shown as a capped needle holder.

FIG. 9 illustrates a cross-section view of a large module shown as a capped needle holder along line B-B.

FIG. 10 illustrates an isometric view of a disposable tray insert and open cell gyroid matrix foam.

FIG. 11 illustrates isometric top view of the universal vial holder aperture.

FIG. 12 illustrates an isometric bottom view of the universal vial holder aperture.

FIG. 13 illustrates a front view of the universal vial holder aperture 100 as if it were transparent.

FIG. 14 illustrates a top view of the flexible holder insert as seen in FIG. 7

FIG. 15 illustrates front view of the flexible holder insert as if it were transparent.

### DETAILED DESCRIPTION OF THE DRAWINGS

FIG. 1 includes the treatment tray base 10 which has at least two portions which provide distinct areas for containing at least one large module 220 in a large module compartment 20 and one small module in a small module compartment 30 each configured to receive and stabilize a respective modular component. The small module is depicted as a universal vial holder base body 90 (base body) In some embodiments, the small module compartment 30 and large module compartment 20 may be the same size. In some embodiments, the small module compartment 30 has a lesser area than the large module compartment 20.

In some embodiments, the treatment tray base 10 has rigid structural body defining a planar support surface 11 bounded by perimeter sidewalls 12 and configured to serve as the foundational component of a modular injector workstation. In some embodiments, the tray base 10 is formed as a monolithic structure using molding or additive manufacturing techniques, and may be constructed from materials such as PLA, PETG, nylon, or other thermoplastic or composite polymers. In some embodiments, the tray base 10 may be compatible with additional workstation components, covers, or mounting features, and may include registration structures or nesting geometry to allow stacking or modular expansion.

The large module compartment 20 and the small module compartment 30 are separated by a bilateral protruding portions 40 and bound by interior side walls 13 of the tray base 10. In some embodiments, the planar support surface 11 transitions to interior side walls 13 via interior corners 14. In some embodiments, the bilateral protruding portions 40 are partial wall segments positioned at opposing ends of the interface boundary between the small module compartment 30 and the large module compartment 20. These protruding geometries are configured to inhibit lateral displacement of removable modules, e.g., large module 220 and small module 90, while maintaining an open central region. The bilateral protruding portions 40 include a small module locating surface 21 and a large module location surface 31. These surfaces 21 and 31 are the portions of the bilateral protruding portions 40 with the small module 90 and large module 220, respectively. This configuration enables improved access to the treatment tray base 10 interior and permitting temporary placement of larger tools or waste items during use when not occupied by their respective modules.

In some embodiments the large module compartment 20 is formed within the tray body and defined by interior walls or boundary surfaces that establish a dedicated volume for receiving a large modular 220. The large module compartment 20 may incorporate protruding geometry, seats, ribs, or spatial guides configured to stabilize the module during use or storage.

In some embodiments the small module compartment 30 is a compartment formed within the tray body and defined by interior walls or boundary surfaces that establish a dedicated volume for receiving a small modular component. The small module compartment 30 may incorporate protruding geometry, seats, ribs, or spatial guides configured to stabilize the smaller module during use or storage.

Bilateral protruding portions 40 separate the large module compartment 20 and small module compartment 30. In some embodiments, the bilateral protruding portions 40 may take the form of localized protruding structures positioned at opposing ends of the former wall boundary as shown in FIG. 1. These structures define partial wall segments configured to maintain physical separation and inhibit lateral shifting of the removable modules, while preserving an open intermediate area. This open configuration permits greater access within the tray and accommodates the placement of larger tools or waste items during use.

In other embodiments, the bilateral protruding portions 40 may take the form of a continuous wall that extends between the large and small module compartments, forming a rigid boundary that provides lateral stabilization and fixed spatial division. This may be embodiment forms a closed configuration.

In both open and closed configurations, the bilateral protruding portions 40 may be formed integrally with the tray body and may include locating surfaces 21 and 31 configured to interface with corresponding edges or surfaces of the removable modules 90 and 220, respectively.

Storage cavities 50 may also be provided to store material, for example, a marking pen/pencil or spare capped needles. In some embodiments, storage cavities 50 may be a plurality of vertically oriented storage cavities, each configured to receive and support a marking instrument, capped needle, or similar accessory in an upright position. The storage cavities 50 may be formed as cylindrical, tapered, flared, or non-circular cross-section interior geometries extending downward from an open upper end, with a depth sufficient to stabilize stored items against tipping or dislodgement and may include internal features such as friction bands, gripping ribs, or textured surfaces to enhance retention. In some embodiments, the cavities 50 are distributed across the treatment tray base 10.

A base surface 11 within each cavity may be closed, contoured, or profiled to assist with axial alignment and containment. These storage cavities 50 may be formed integrally within the treatment tray base or distributed across the modular components. The outer portion of the treatment tray base 10 may also include subtle bilateral ergonomic indentations 60 which may include a stippled or other texturing to provide grip when handling and improve manual handling during repositioning or transport.

In some embodiments, the treatment tray base 10 also includes ergonomic indentations 60. The ergonomic indentations 60 may include a stippled texture to provide enhanced grip when handling treatment tray base 10. In some embodiments, there are at least two ergonomic indentation 60 positioned bilaterally along opposing exterior sides of the treatment tray base 10 configured to accommodate finger contact. Each ergonomic indentation 60 includes a textured surface with a stippled or raised pattern to increase grip and handling control during transport or repositioning.

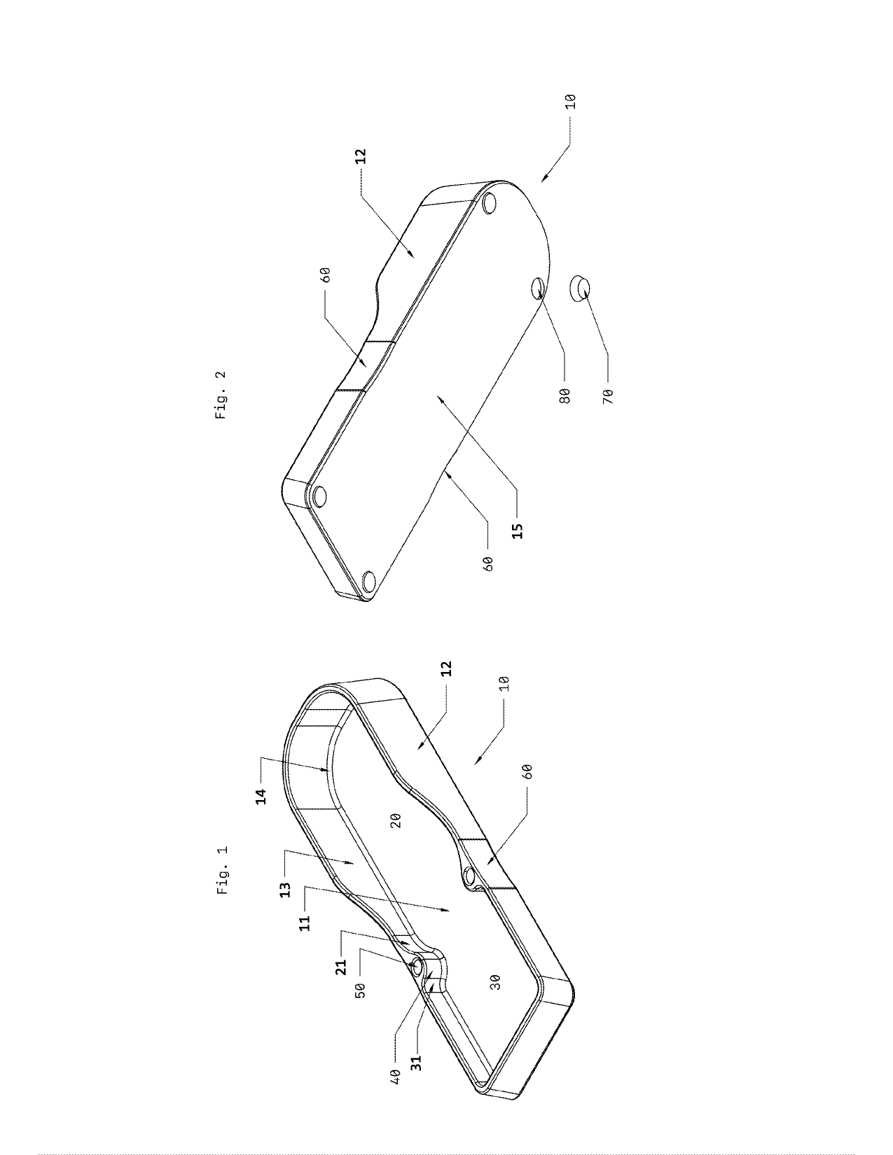

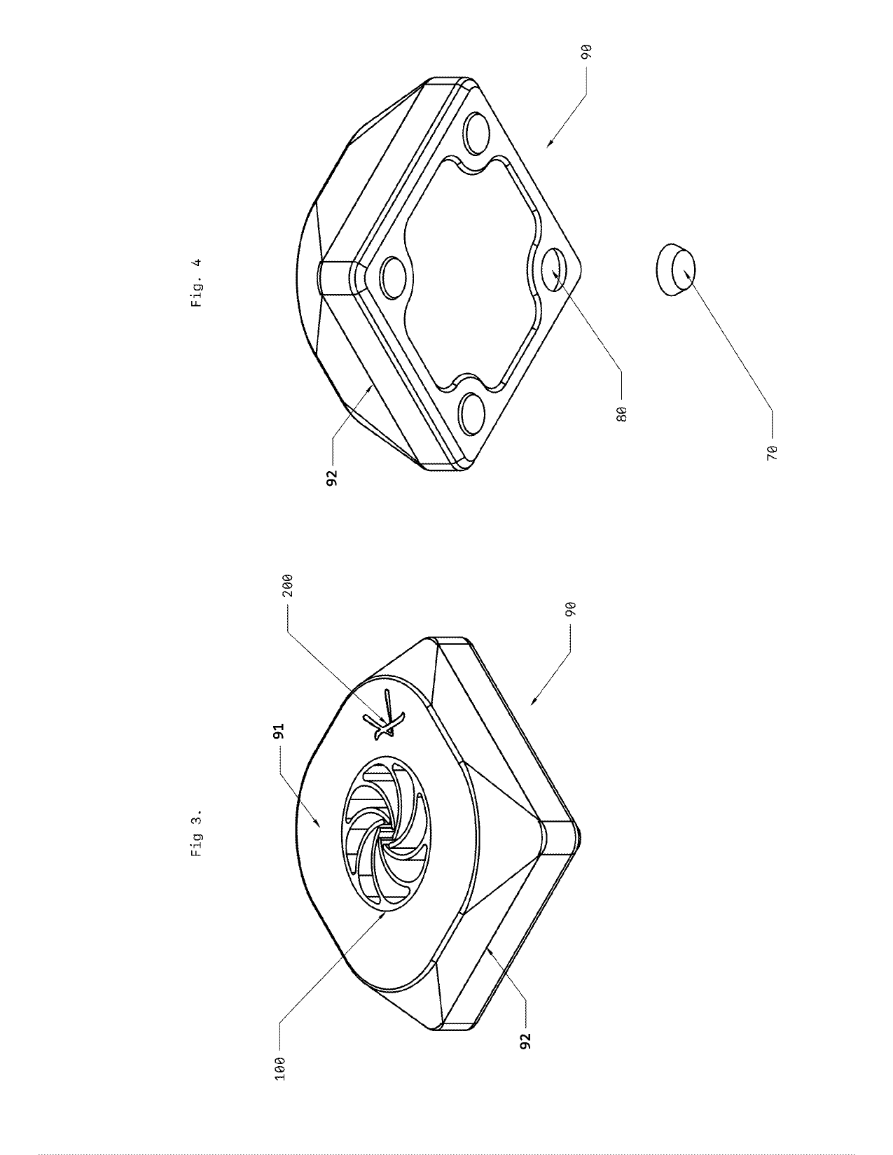

FIG. 2 shows a bottom view of the tray base 10 including an underside surface 15 of the tray base 10 may define one or more cavities 80 configured to receive anti-skid feet 70 formed of a compliant material such as rubber or thermoplastic elastomer. The cavities 80 are formed on the underside of the tray base and are each configured to receive and retain an anti-skid foot 70. The cavities 80 may be shaped to provide a press-fit, adhesive bond, or mechanical retention depending on the foot design. These anti-skid feet 70 are configured to frictionally engage a horizontal support surface, thereby increasing stability during use.

There may be one or more anti-skid feet 70 which may be formed of a compliant or elastomeric material are configured to couple with corresponding cavities 80 on the underside of the treatment tray base 10. Each foot 70 is dimensioned to frictionally engage a horizontal support surface, thereby increasing stability during use and inhibiting unintended movement of the tray.

The feet 70 may be formed, for example, from rubber, thermoplastic elastomer (TPE), silicone, or other suitable compliant materials, and may be coupled to the tray body via press-fit, adhesive bonding, mechanical interlock, or insert-molding. In some embodiments, the feet are removable and replaceable; in others, they may be permanently affixed.

The geometry of each foot 70 may include a cylindrical or frustoconical body with a planar contact face, a recessed stem for insertion into a retention cavity, or an undercut to enhance mechanical retention. The contact surface of each foot 70 may be smooth, ribbed, or textured to improve traction and surface conformity. Feet may be configured symmetrically or asymmetrically, and may vary in durometer, thickness, or profile to accommodate different clinical environments or surface types.

Interior corners 14 formed at junctions between the base 11 and sidewalls 13, as well as within compartments 20 and 30 and storage cavities 50, may define radiused, chamfered, or otherwise curved transitions. These geometries are configured to inhibit the accumulation of debris, facilitate cleaning, and support clinical sanitation protocols.

FIG. 3 shows a top perspective view of a universal vial holder base body 90. The base body 90 is a rigid modular component dimensioned to be received within the small module compartment 30 of the treatment tray base 10. The base body 90 defines a generally planar upper surface 91 and surrounding perimeter walls 92 which provides a contained volume for supporting an integrated universal vial holder aperture 100. In the depicted embodiment, the base body 90 is specifically configured to retain the vial holder aperture 100 in a fixed, upright position during use. However, in alternative embodiments, the body 90 may be customized to include additional upright cavities for receiving marking instruments, capped needles, or similar accessories. A logo or other design 200 may be incorporated into the universal vial holder aperture 100.

FIG. 4 shows a bottom view of the universal vial holder base body 90 and includes at least one cavity 80 on the underside of the universal vial holder base body 90 that is configured to receive a foot 70. The foot 70 is dimensioned to frictionally engage a horizontal support surface, thereby increasing stability during use and inhibiting unintended movement of the universal vial holder base body 90. The feet 70 may be press-fit, adhesively bonded, or mechanically retained, and may be removable or permanently affixed depending on design intent.

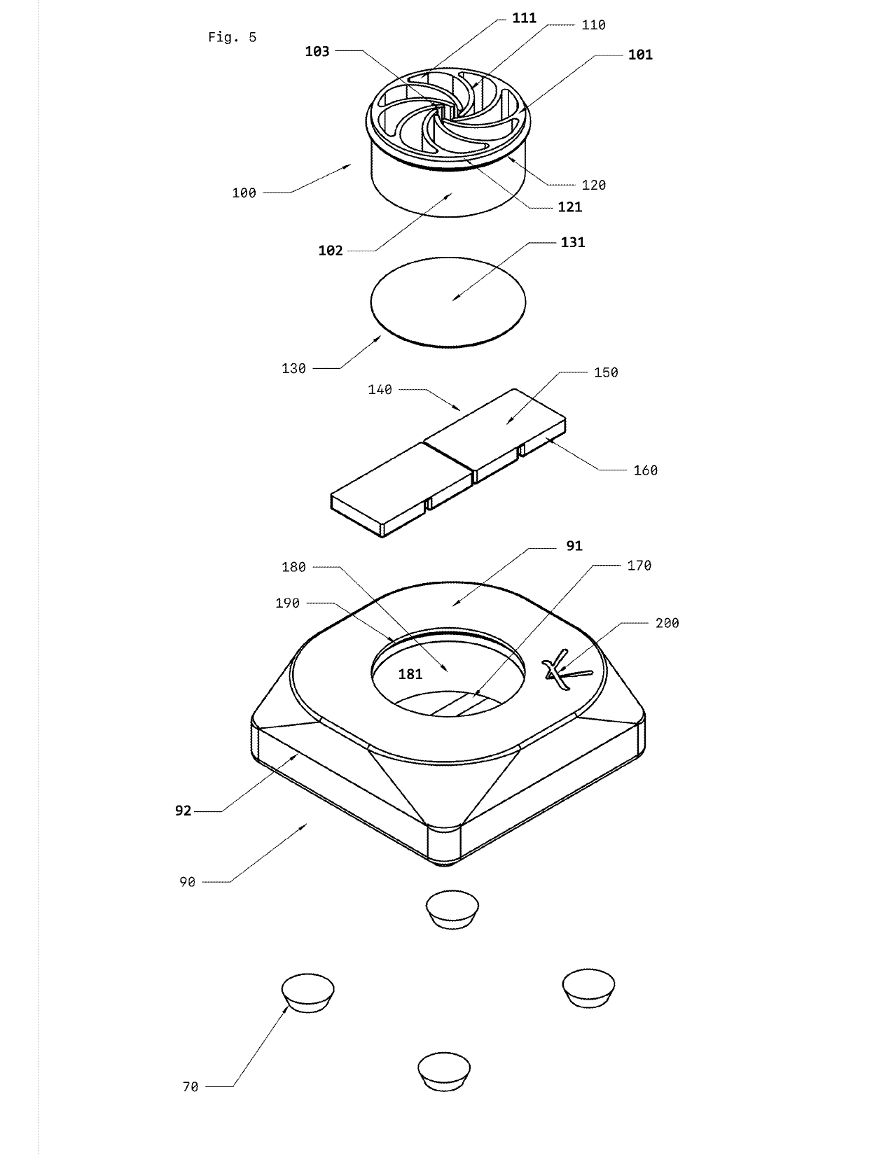

FIG. 5 shows a top perspective exploded view of a small module 90 universal vial holder 100. The upper surface 91 of the universal vial holder base body 90 defines a central cylindrical cavity 180 which extends into the universal vial holder base body 90, for example, about 25% to about 75% the depth of the body, for example, about two-thirds the depth of the body. This cylindrical cavity 180 is configured to receive the vial holder aperture 100.

The universal vial holder base body 90 further includes an underlying tunneled or undermining cavity 170 extending laterally along the bottom of the cylindrical cavity 180. The undermining cavity 170 is configured to receive one or more segmented weights 140. The segmented weights 140 may comprise a plurality of weights 160 and at least one adhesive backing 150. The weights 160 can be inserted with the adhesive backing 150 oriented upward. Once weights 160 are inserted, a circular chip or cover plate 130 is placed into the cylindrical cavity 180 above the undermining cavity 170 to seal the undermining cavity 170 and establish a continuous cylindrical profile for subsequent insertion of the vial holder aperture body 100. This construction allows the base body 90 to incorporate mass for stabilization while maintaining a structurally consistent aperture mount.

In some embodiments, the base body 90 may further include lateral constraint features such as perimeter walls, internal ribs, or interface shoulders to inhibit tipping and provide lateral support to the inserted vial and aperture assembly. Mechanical alignment features such as locating ribs, mating shoulders, or indexed protrusions may be formed along the base perimeter to interface with corresponding tray structures for consistent placement within the small module compartment. A logo 200 or branding feature may be formed, embossed, or printed on the upper surface.

In some embodiments, the base body 90 may also be configured to operate independently of the tray base 10, functioning as a standalone accessory for organizing and stabilizing injection-related materials. In some embodiments, the base body 90 is formed as a monolithic part using additive manufacturing techniques such as fused deposition modeling (FDM) with materials including PLA, PETG, nylon, or other thermoplastics. Alternatively, the base body 90 may be formed through injection molding or multi-part assembly depending on production requirements.

The universal vial holder aperture 100 is a generally cylindrical insert configured to be mounted within the cylindrical cavity 180 of the universal vial holder base body 90. The universal vial holder aperture 100 defines a central axis 103 and a cylindrical internal passage partially occluded by a plurality of inward-extending flexible fin 110 appendages. Each fin 110 originates at or near the inner wall 111 of the universal vial holder aperture body 100 and extends toward the central axis 103 at a non-orthogonal angle. In preferred embodiments, each fin 110 exhibits a curved profile along its length, forming a smooth arc directed either clockwise or counter-clockwise relative to the central axis 103. In alternative embodiments, the fins 110 may extend linearly without curvature while maintaining the same angular orientation.

Each fin 110 may form both acute and obtuse angles with the inner cylindrical wall 111 depending on its orientation and degree of curvature. In the depicted configuration of FIG. 5, all fins are uniformly canted in the same rotational direction to promote consistent deformation and retention behavior during vial insertion.

The fin appendages 110 may be integrally and/or monolithically formed as a part of the universal vial holder aperture 100 and comprise a flexible, durable material, such as thermoplastic polyurethane (TPU) selected for its high elastic memory and repeated deformation resistance with, for example, a shore hardness of approximately 95A. The material selection and geometry allow each fin 110 to elastically deform during vial insertion and then return to a neutral position upon removal. This enables the universal vial holder aperture 100 to accept a wide range of vial diameters while maintaining a consistent friction-fit engagement. The curved fin 110 geometry in the preferred embodiments improves the uniformity of contact and enhances circumferential grip during insertion and rotation.

In some embodiments, a vial may be inserted at an angle of, e.g., approximately 45, or less, degrees and rotated into place. During this insertion, the fins 110 flex outward in response to radial pressure, generating a distributed resistance force that retains the vial. The friction between the fins 110 and the vial surface, along with the restoring force of the flexible material, produces a secure fit capable of supporting the vial even in an inverted position. In some embodiments each fin 110 is configured to elastically deform in response to contact with a vial during insertion and to return to its original geometry upon removal. The combination of angular orientation and curvature enables the fin to generate radial compression against the vial’s outer surface, producing a distributed frictional engagement. This interaction provides sufficient retention force to support the vial in various orientations, including inversion.

The number of fins 110 may vary by design, including configurations with 4 to 12 fins 110, such as 4, 5, 6, 7, 8, 9, 10, 11, or 12. The internal geometry is configured to accept vial diameters occupying between approximately 20% and 80% of the inner diameter of the aperture body, including narrower preferred ranges such as 25%–75%, 33%–66%, 40%–60%, or 45%–55%. The number of fins 110, their spacing, and degree of curvature may be varied to accommodate different vial diameters and insertion profiles, supporting compatibility across a wide range of standardized vial sizes.

In some embodiments, the overall fin assembly including fins 110, behaves in a manner functionally analogous to a camera aperture, flexing passively in response to insertion pressure and returning to a rest state when unloaded. No manual adjustment is required. The universal vial holder aperture 100 may be removably or permanently retained within the base body, depending on the method of integration. It may be manufactured monolithically by additive manufacturing, insert molding, or overmolding processes using elastomeric polymers.

In some embodiments, a continuous protruding ring 120 is provided circumferentially around the outer wall 102 of the universal vial holder aperture 100. The ring 120 is positioned near the upper portion 121 of the universal vial holder aperture 100 and is configured to engage a corresponding internal feature, such as, a ledge, shoulder, or recessed groove within the cylindrical cavity 180 of the base body 90.

The protruding ring 120 is dimensioned to create an interference or friction fit, thereby retaining the universal vial holder aperture 100 securely in position during use. When fully inserted, the protruding ring 120 establishes a seated condition in which the upper surface 101 of the universal vial holder aperture 100 is flush with the upper surface 91 of the base body 90 as depicted in Fig.3. The protruding ring 120 geometry may include a rounded, beveled, or radiused cross-section to aid in insertion alignment and distribute retention forces uniformly around the circumference.

In some embodiments, the protruding ring 120 functions as a passive locking and alignment feature that eliminates the need for adhesives or fasteners. This configuration allows the universal vial holder aperture 100 to be removed and replaced without damaging surrounding components, enabling retrofit capability for replacement or upgraded versions. The design supports backward compatibility across production runs, allowing end users to interchange updated universal vial holder apertures 100 with earlier versions of the base body 90.

The protruding ring 120 is integrally formed with the universal vial holder apertures 100 and composed of the same flexible or semi-rigid material, such as thermoplastic polyurethane (TPU), to ensure dimensional compliance and durability across repeated installation and removal cycles.

The chip or cover plate 130 is a disc-shaped insert configured to be positioned at the base of the cylindrical cavity 180 formed in the universal vial holder base body 90. The chip or cover plate 130 functions as a sealing interface between the cylindrical cavity 180 above and the underlying tunneled or undermining cavity 170 that houses one or more segmented weights 140. Once installed, the chip or cover plate 130 closes off the segmented weights 140 and defines the lower boundary of the cylindrical cavity 180 used to retain the universal vial holder aperture 100.

The upper surface 131 of the chip or cover plate 130 serves as the bottom contact platform against which an inserted vial ultimately rests when seated within the aperture body 100. The chip or cover plate 130 is externally visible when viewed from above through the flexible fins 110 of the aperture 100 and may influence the insertion depth of the vial based on its thickness and elevation.

The chip or cover plate 130 may define a circular or beveled perimeter to facilitate alignment and insertion, and may be press-fit, friction-fit, or adhesively bonded into place depending on serviceability requirements. In some embodiments, the chip or cover plate 130 is removable to allow access to the segmented weight 140 for repositioning or replacement of the segmented weight 140. In other embodiments, the chip or cover plate 130 may be permanently affixed to prevent unintended displacement.

The chip or cover plate 130 may be constructed from a rigid or semi-rigid material such as PLA, PETG, ABS, or another thermoplastic compatible with additive manufacturing or conventional molding processes.

In some embodiments, a segmented weight 140 what is flexible and comprises a plurality of discrete weight segments 160 arranged in linear succession and joined by a common backing layer 150. Each segment 160 defines a generally rectangular or trapezoidal solid mass with a nominal mass of approximately one-quarter ounce (0.25 oz). In the depicted embodiment, the strip consists of four segments 160, selected to provide a combined weight sufficient to significantly lower the center of gravity of the small module, i.e., universal vial holder base body 90.

The segmented weight 140 is positioned within a tunneled or undermining cavity 170 formed in the lower region of the universal vial holder base body 90. The adhesive side 150 of the strip 140 is oriented upward, securing the strip to the internal ceiling of the cavity 170 while allowing the mass of the segments 160 to occupy the lowest possible vertical position within the component’s volume. This placement is configured to optimize balance and prevent tipping or rollover of the universal vial holder base body 90, even when subjected to extreme angular displacement approaching ninety degrees from horizontal.

The segmented weight 140 is installed in a fixed position using a pressure-sensitive adhesive backing 150 protected by a removable liner. Once adhered, the segmented weight 140 remains enclosed within the base structure of the universal vial holder base body 90 and does not interfere with the installation of the chip or cover plate 130 or the vial holder aperture 100 above.

Each weight segment 160 may be composed of steel, zinc, or another dense metallic material. The backing of the adhesive backing layer 150 may be formed from a flexible polymer or metallic film to conform to the cavity geometry. The adhesive of the adhesive backing layer 150 is selected for permanent retention under typical usage conditions.

The tunneled or undermining cavity 170 is an internal recess formed within the lower region of the universal vial holder base body 90. It is configured to receive the segmented weight strip 140.

The cavity 170 originates from and extends laterally beneath the cylindrical cavity 180 that retains the vial holder aperture body 100. The cavity 170 is formed as a horizontally tunneled channel or shelf cut into the interior volume of the base, terminating in an enclosed or partially enclosed region. The cavity 170 is dimensioned to accommodate the full length and width of the segmented weight 140, with sufficient ceiling surface area to permit full contact with the adhesive backing 150.

In the assembled state, the adhesive side 150 of the weight strip 140 is secured to the upper interior surface of the undermining cavity 170, while the mass of the weights 160 is suspended below the chip or cover plate 130. This arrangement enables the chip or cover plate 130 to be installed above the cavity opening without interference and provides a flush or continuous surface for the aperture body 100.

The cavity 170 is not externally visible in the final assembly but may be accessed during production or servicing through the central cylindrical cavity 180 prior to installation of the chip or cover plate 130. The geometry of the cavity 170 may be rectangular, arcuate, or shaped to follow the profile of the segmented weight. The cavity 170 is formed integrally within the monolithic structure of the base body and may be created using additive manufacturing or subtractive techniques depending on production method.

The cavity 180 for the universal vial holder aperture 100 is a cylindrical recess formed in the upper surface 91 of the universal vial holder base body 90. It is dimensioned to receive and retain the aperture body 100 in a seated position, aligning its central axis with that of the base. The cavity 180 defines a vertical bore with smooth or slightly relieved inner walls 181 configured to accommodate the full outer profile of the aperture body, including the integrated friction-fit ring 120.

The depth of the cavity 180 is bounded by the installed chip or cover plate 130, which forms the base surface of the cavity 180. The cavity 180 thus defines the full insertion volume of the aperture body 100 and determines the final resting depth of an inserted vial. The geometry ensures that when the aperture body 100 is fully seated, its upper surface is flush with the upper surface 91 of the base body 90, and the aperture body 100 remains secured against lateral or vertical displacement.

In a preferred embodiment, the cavity 180 is centrally located within the upper surface 91 of the base body 90. However, this placement is not a structural necessity. The cavity 180 may be repositioned anywhere within the spatial confines of the small module or other compatible modular components, provided there is sufficient surrounding material to support full integration and maintain structural integrity. This flexibility supports future design adaptations or reconfigurations based on alternate module geometries or functional layouts.

In some embodiments, the cavity 180 may include internal guide features, alignment surfaces, or minor undercuts to facilitate press-fit or friction-fit engagement with the aperture body. The cavity 180 may be integrally formed as part of the monolithic structure of the base body and may be produced via additive manufacturing or molding.

In some embodiments, the cavity 180 includes an indentation 190 for the protruding ring 120 of the universal vial holder 100. This indentation 190 is a shallow annular recess formed along the upper rim of the cylindrical cavity 180. This feature is specifically dimensioned to accommodate the protruding ring 120 of the universal vial holder 100 and can secure the universal vial holder 100 to the base body 90 via a friction fit between the indentation 190 and the protruding ring 120.

This indentation 190 enables the protruding ring 120 to seat securely, creating a flush and stable interface between the top surface 91 of the base body 90 and the installed vial holder aperture 100. The mating geometry serves two primary functions:

1. Axial Retention – The interference fit between the protruding ring 120 and the indentation 190 ensures that the aperture body 100 resists vertical displacement or unintentional removal during normal use; and

2. Rotational Alignment – The defined geometry may also serve as a radial locator, aligning the aperture body 100 in a consistent rotational orientation relative to the small module base body 90 if required.

In some embodiments, the indentation 190 may be formed as a continuous groove or as a series of discrete detents or shoulders, depending on manufacturing constraints or desired retention characteristics. In preferred embodiments, the indentation 190 is a circular channel with dimensions that match the diameter and profile of the integrated ring, and is capable of providing an audible or tactile "snap" fit upon full insertion.

This the indentation 190 is formed integrally with the cylindrical cavity 180 during manufacturing and is flush with or slightly recessed below the upper surface 91 of the base body 90. The indentation 190 may include a minor lead-in taper or chamfer at the entry edge to assist with guided insertion of the aperture body.

The logo 200 is a raised or engraved graphic element formed on the top-facing surface 91 of the small module base body 90. It serves as a brand identification feature and may be presented in the form of text, iconography, or a combination thereof. In the preferred embodiment, the logo 200 is located in a visible, non-obstructive region of the module's top plane, outside the operational path of the universal vial holder aperture 100.

In some embodiments, the logo 200 functions as a visual orientation marker to assist a user in aligning the small module base body 90 in the correct rotational or directional orientation within the treatment tray base 10.

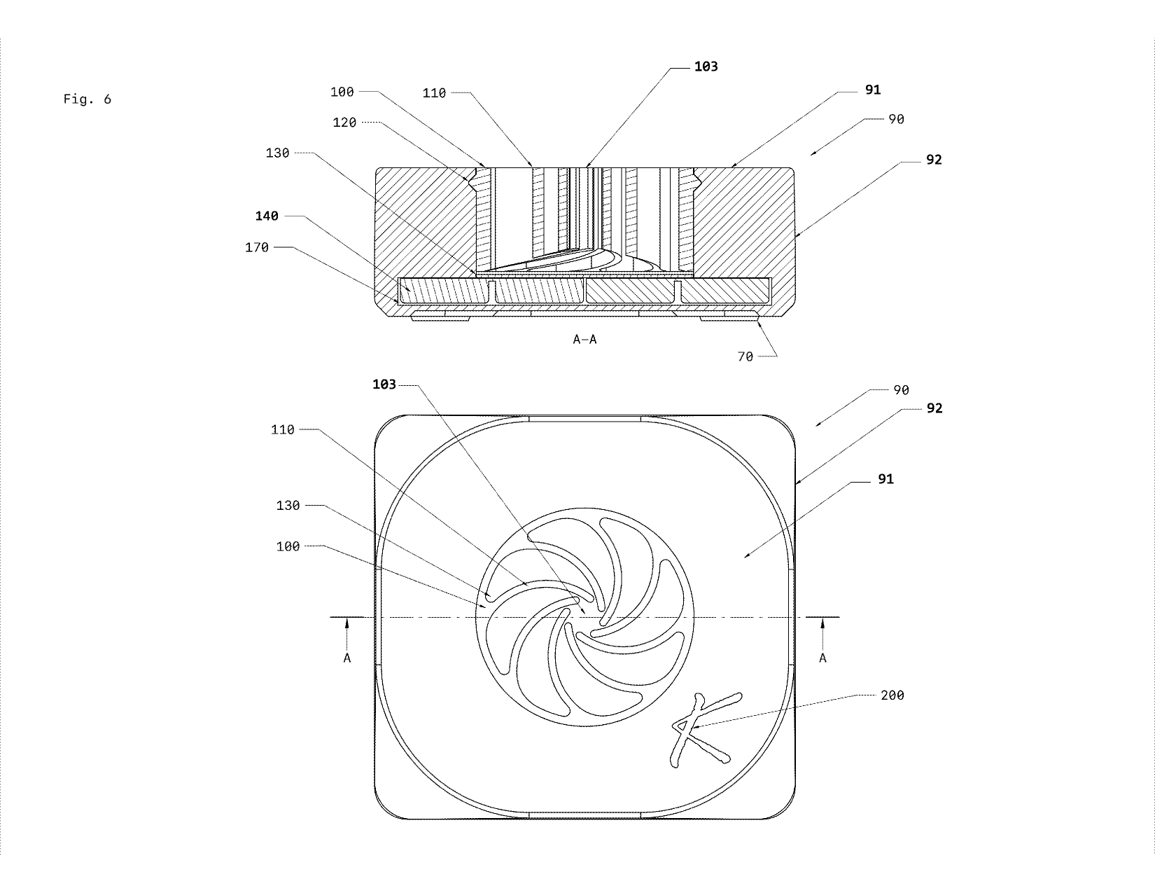

FIG. 6 illustrates a cross section view of a small module shown as universal vial holder base body 90 along line A-A. Line A–A represents a coronal (frontal) cross-sectional plane that bisects the fully assembled embodiment of the universal vial holder base body 90. This sectional view cuts through the structure longitudinally, allowing visual inspection of the entire component stack from the upper surface 91 of the base body 90, through the inserted Universal Vial Holder Aperture 100, down to the internal segmented weight 140 and underlying tunneled or undermining cavity 170.

Features shown even more clearly in FIG. 6, include:

The relationship between the aperture body 100 and the cavity 180 for the aperture body 100;

The placement and retention of the protruding ring 120 in the indention 190;

The underlying chip or cover plate 130 seated at the base of the cylindrical cavity 180, which simultaneously acts as a seating platform for the inserted vial and as a barrier separating the cylindrical cavity 180 from the underlying tunneled or undermining cavity 170;

The positioning and orientation of the segmented weight 140, enclosed within the tunneled cavity and bonded via adhesive backing 150; and

The overall depth profile and stacking order of these subcomponents in their installed configuration. This sectioned view also shows how axial alignment, modular friction locking, and weighted stabilization are achieved within the confined geometry of the small module base body 90 and illustrates retention interfaces and internal housing geometries.

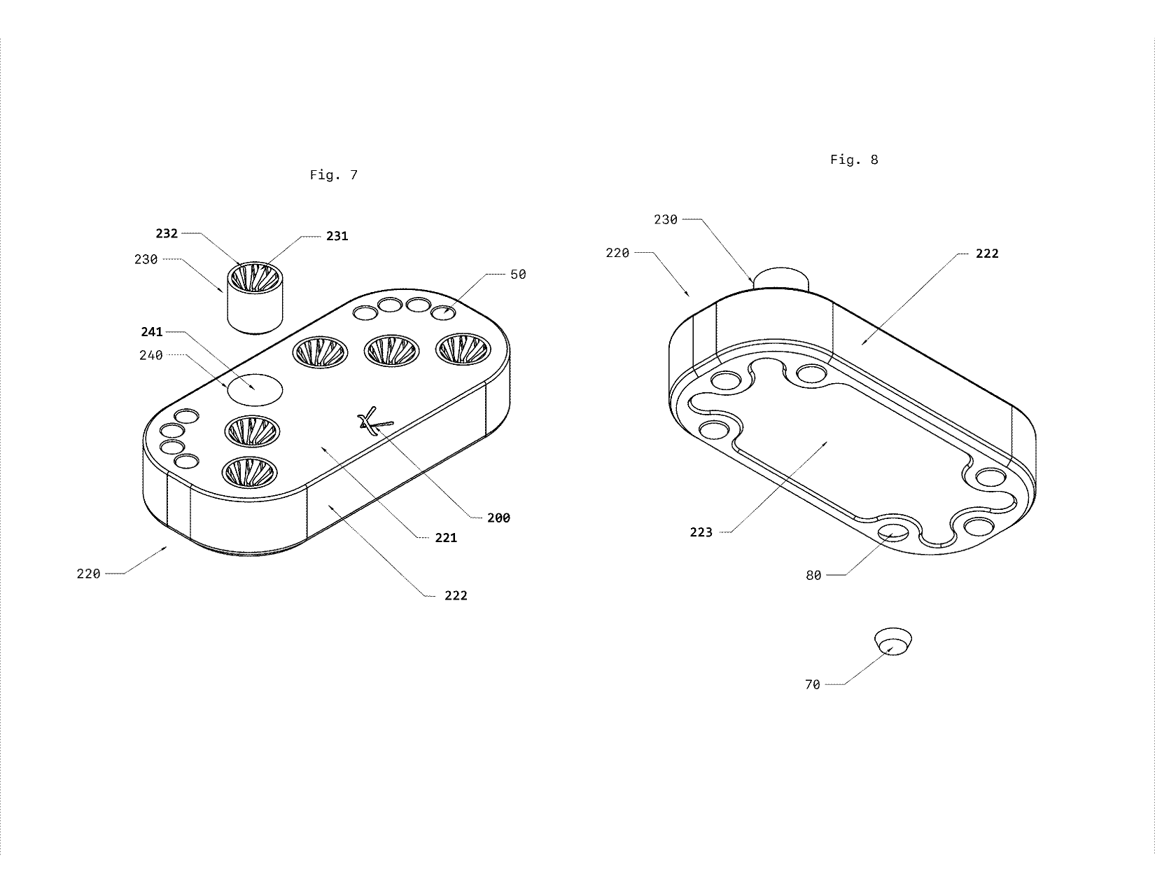

FIG. 7 illustrates a top perspective view of a large module body 220 shown as a capped needle holder. The large module body 220 is a modular component designed to interface with the large module compartment 20 of the treatment tray base 10. The large module body 220 serves as a removable, self-contained organizational unit intended for upright storage of multiple accessories used in medical aesthetic procedures most notably syringes with fastened capped needles, unfastened capped needles, and marking instruments in this embodiment.

For example, large module body 220 houses a series of flexible holder inserts 230, made of a resilient, flexible material such as TPU (thermoplastic polyurethane). In the depicted embodiment, the module includes six (6) inserts, though the number may vary depending on future adaptations, for example, 1, 2, 3, 4, 5, 6, 7, 8, 9, 10, 11, and so on.

Each flexible holder insert 230 is recessed into the upper surface 221 of the large module body 220 into the capped needle cavity 240 in the large module body 220. The flexible holder insert 230 comprises a generally cylindrical aperture 232 with straight, canted fins 231 extending inward from the perimeter. The canting of the fins 231 creates a slight helical or corkscrew configuration, facilitating a friction-fit engagement when a capped needle is inserted. This configuration allows for secure retention of items stored, for example, capped needles while still permitting easy removal, ensuring rapid workflow during treatment procedures.

The large module body 220 also includes at least one and preferably a plurality of vertically oriented cavities 50, for example, from 2 to 20, for example, 1, 2, 3, 4, 5, 6, 7, 8, 9, 10, 11, and so on. In the depicted embodiment eight vertically oriented cavities 50 are shown and are of the same type and may be used for marking pens or pencils. The vertically oriented cavities 50 may be structurally equivalent to the vertically oriented cavities 50 provided in the treatment base 10 shown in FIG. 1.

While these cavities 50 may not optimized for tight needle retention, they may serve as secondary storage for capped needles or miscellaneous slim instruments, providing flexible use-case versatility.

The large module body 220 may also include rubber anti-skid feet 70 and matching cavities 80 positioned on its underside to prevent lateral sliding or tipping during use as previously described. The large module body 220 may also be weighted internally or structurally reinforced to maintain stability under load, especially when holding multiple instruments upright.

The large module body 220 is shaped to conform to the spatial constraints of the large module compartment 20 and may interface with surrounding protruding geometry 40 that provides lateral stabilization. The large module body 220 may be removable and replaceable, offering future compatibility with additional module variations or upgraded insert designs. The large module body 220 may optionally include branding elements or logos 200 on its top surface 221. The logo 200 provides a similar/same function to that described in the context of the small module base body 90.

The flexible holder insert 230 of the large module body 220 is a flexible, press-fit retention structure formed from a durable elastomeric material such as thermoplastic polyurethane (TPU). It is designed to accommodate, for example, capped needles commonly used in medical aesthetic procedures and/or similarly shaped accessories. Each flexible holder insert 230 is dimensioned to fit into dedicated capped needle cavity 240 within the Large Module Body 220, and is configured for both secure storage and safe hands-free interaction with needle-capped syringes.

The flexible holder insert 230 is generally cylindrical with inward-extending fins 231 along the interior wall 233. The fins 231 of the flexible holder insert 230 are straight rather than curved and are canted to form a gentle corkscrew profile that facilitates rotational interaction. The interior fins 231 are dimensioned and spaced to create a tight friction fit around the plastic cap of the needle, rather than the metal needle or syringe barrel.

The flexible holder insert 230 may be constructed of TPU or an equivalent/similar material which provides the necessary flexibility, resilience, and repeated-use durability.

The above provides the following advantages:

Hands-Free Cap Retention: when a capped needle is attached to a syringe and inserted into the holder, the frictional grip of the fins 231 against the needle cap exceeds the retention force between the needle hub and the cap.

Revealing the Needle: when the user withdraws the syringe, the needle remains locked to the syringe, and the cap remains held in the insert, revealing the sterile needle tip without requiring any hand contact with the cap.

One-Handed Recapping: the flexible holder insert’s 230 rigid upright orientation and secure grip on the cap enable the injector to safely guide the exposed needle back into the cap with a single hand minimizing exposure risk and preventing accidental needle sticks.

Luer Lock Compatibility: If desired, the injector may rotate the syringe counterclockwise after re-inserting the exposed needle into the retained cap, disengaging the needle via the luer-lock mechanism. This allows for quick needle replacement using another capped needle secured in an adjacent insert without hand contact throughout the exchange process.

This flexible holder insert’s 230 provides a compact, self-contained, and safety-enhancing needle exchange solution for injectors. It reduces the need for a second hand during needle uncapping or recapping, and ensures capped needles remain upright and accessible, minimizing fumbling and improving workspace organization.

The capped needle cavity 240 is a dedicated receiving feature formed in the large module body 220 and is engineered to retain and support the flexible insert 230 in a secure and functional position. This cavity 240 defines the spatial constraints and insertion depth for the insert and facilitates proper alignment for intended use during needle loading and removal procedures.

The cavity 240 is generally cylindrical in shape, matching the outer profile of the flexible insert 230 to ensure a tight press fit or interference fit. In some embodiments, the walls 241 may be slightly tapered to allow for easier insertion and improved seating security. The cavity 240 defines a fixed depth to maintain the correct vertical alignment of the insert relative to the module’s upper surface 221. This ensures the cap of the needle is held at an optimal height for both insertion and withdrawal of syringes. Depending on the embodiment, the cavity 240 may include internal retention geometries such as friction bands, undercuts, or ribbing to provide additional locking strength, especially when subject to repeated use and cleaning cycles.

The cavity 240 provides a stable foundation for the flexible holder insert 230, preventing lateral shift, rotation, or dislodgment during use. This is particularly important when the user exerts axial force during syringe insertion or removal. By defining the fixed position of the flexible holder insert 230, the cavity 240 ensures proper vertical orientation of the capped needle. This alignment is essential for the functional behavior of the insert, namely, enabling hands-free cap retention during needle exposure and secure recapping. The flexible holder insert 230 can be removed and replaced as needed without damaging the cavity 240 or large module body 220. This allows for modular upgrades or component replacement, supporting long-term usability and maintainability of the tray system.

FIG. 8 illustrates a bottom perspective view of a large module 220 shown as a capped needle holder. This perspective illustrates the anti-skid feet 70 and cavities 80 that are formed on the underside of the large module body 220. These elements are described above in the context of the tray base 10. The cavities 80 may be shaped to provide a press-fit, adhesive bond, or mechanical retention depending on the foot 70 design. These anti-skid feet 70 are configured to frictionally engage a horizontal support surface, thereby increasing stability during use.

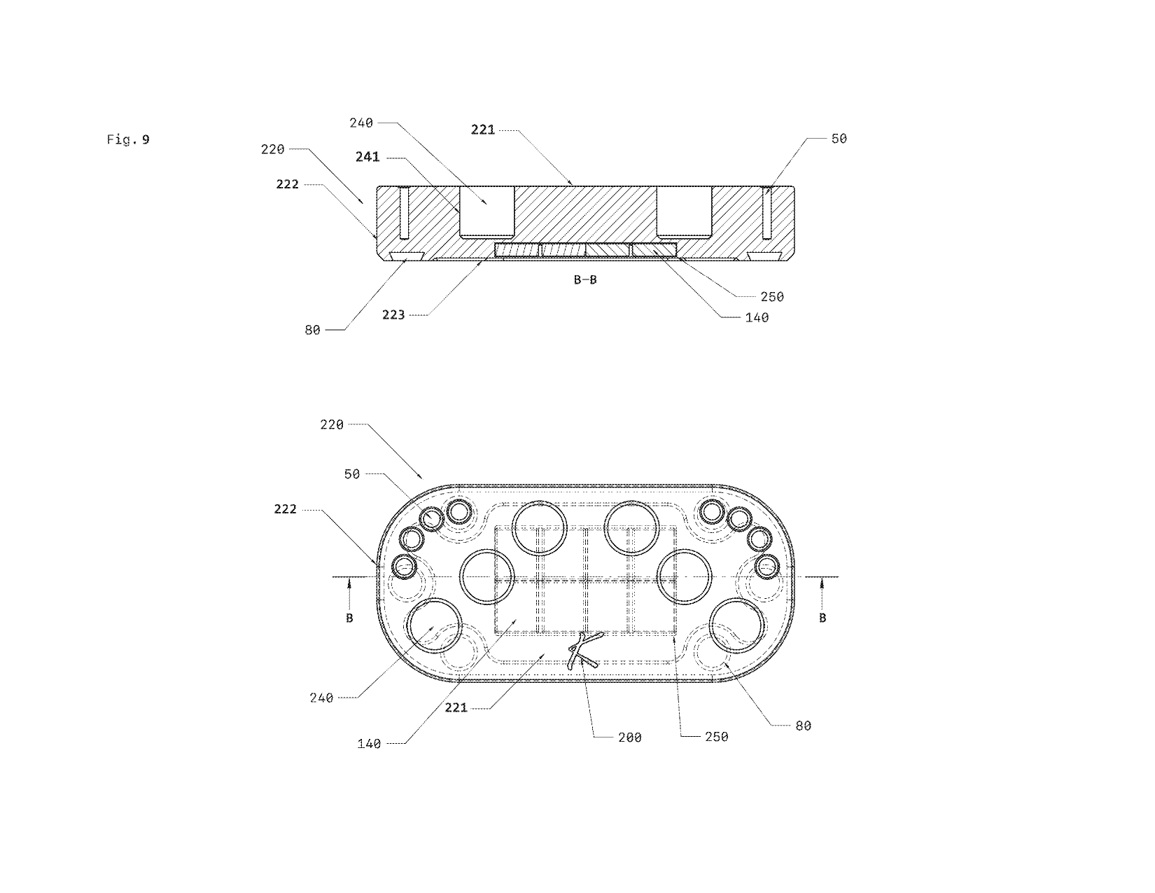

FIG. 9 illustrates a cross-sectional view of a large module 220 shown as a capped needle holder along line B-B.

As seen in the cross-sectional view there are one or more enclosed internal compartments 250 integrated within the large module body 220. The enclosed internal compartments 250 are configured to permanently house segmented weights 140 for the purpose of lowering the center of gravity and enhancing stability. These enclosed internal compartments 250 are dimensioned to receive one or more ¼ oz segmented weights 140 during the manufacturing process.

In the depicted embodiment, the enclosed internal compartments 250 are filled by pausing the additive manufacturing process at a predetermined layer height, manually inserting the segmented weights 140, and then resuming printing to encapsulate them entirely within the structure. This method allows the weights to be fully enclosed with no post-production access. This particular structure is not limited to only this manufacturing process.

In alternate embodiments, the enclosed internal compartments 250 may be designed to receive weights 140 post-production via a secure opening on the underside of the large module body 220. This variant includes a dedicated access port or cap closure feature, which allows for maintenance, replacement, or customization of the ballast configuration without compromising the module’s structural integrity or aesthetic form.

The inclusion of enclosed internal compartments 250 ensures that the mass of the large modular body 220 is concentrated toward its base, improving its resistance to tipping, even when subjected to off-axis forces or uneven loading during clinical use.

FIG. 10 shows an isometric view of a disposable tray insert 260 and open cell gyroid matrix foam 270. The disposable tray insert 260 includes a cavity 280 for the open cell gyroid matrix Foam 270 and an open compartment 290 for receiving and storing waste items. The open cell gyroid matrix foam 270 and cavity 280 for the open cell gyroid matrix foam 270 can take a variety of shapes but shape of the cavity 280 will always be complementary to, even if not the same as, the shape of the open cell gyroid matrix foam 270 so that it can function to receive it.

In some embodiments, the disposable tray insert 260 is designed to conform to the internal profile of the large module compartment 20 within the treatment tray base 10. The disposable tray insert 260 functions as a waste collection tray and is configured for single-use or disposable implementation to support sanitary workflow practices. The body of the disposable tray insert 260 is contoured to nest securely within the footprint of the large module compartment 20 with sufficient vertical and lateral clearance to allow smooth insertion and removal. Perimeter tolerances are optimized for minimal lateral shifting while preserving ease of placement and disposal.

The disposable tray insert 260 includes a laterally oriented partial-height dividing wall, segmenting the internal volume into at least two distinct functional zones including a cavity 280 for the open cell gyroid matrix foam 270 and an open compartment 290 for receiving and storing waste items.

The cavity 280 for the open cell gyroid matrix foam 270 can occupy approximately one portion of the insert’s interior footprint, this cavity 280 is designed to house a disposable open cell gyroid matrix foam 270. The open cell gyroid matrix foam 270 acts as a passive containment medium for soiled, contaminated, or used needle tips or cannulas.

The floor of this cavity 280 is solid and continuous, with no perforations, meshes, or apertures. This safety feature prevents accidental puncture or breach by sharp objects and supports hygienic containment.

The open compartment 290 for receiving and storing waste items can occupy the remaining open portion of the tray body 260 is configured to hold miscellaneous disposable items such as empty syringes, discarded caps, gauze, or packaging waste. In some embodiments, the floor of the open compartment 290 may be either solid, offering complete containment, or a lattice-style mesh, which may reduce material usage, facilitate visual inspection, or support drainage where appropriate. The mesh design, if used, maintains structural rigidity and is not intended for containment of liquids or sharps.

The tray insert 260 may be constructed from a lightweight, injection-moldable or thermoformable polymer suitable for single-use. It is able to be discarded after each procedure or clinical session, aligning with infection control protocols.

In some embodiments, the open cell gyroid matrix foam 270 is a purpose-designed, infill-only component fabricated using Fused Deposition Modeling (FDM) 3D printing technology. The open cell gyroid matrix foam 270 can be constructed from a thermoplastic polyurethane (TPU) filament, offering both durability and elasticity. This open cell gyroid matrix foam 270 is engineered specifically to occupy a designated compartment within the tray insert 260, itself nested within the larger treatment tray system 10.

In some embodiments, the internal structure of the open cell gyroid matrix foam 270 is generated by removing all perimeter walls, top surfaces, and bottom layers from a printed model, leaving only the infill. While gyroid is preferred in this embodiment for its continuous curvature and structural integrity, alternative patterns may be used depending on functional needs. In this case, the gyroid structure produces a 'pillow top' aesthetic and functional surface with open segments ideal for puncture retention.

The infill pattern can be specifically oriented and tuned in slicer software to optimize both mechanical resilience and puncture-holding ability. Density and pattern orientation are carefully controlled to allow needle insertion while maintaining vertical load-bearing capacity.

Puncture Retention: The open-cell matrix design permits secure insertion and retention of used needle and syringe assemblies. The structure is rigid enough to support the full weight of a loaded syringe in an upright position after needle insertion, without tipping or collapsing.

Needle Safety and Workspace Efficiency: When combined with the tray insert 260and housed within the cavity 280, the open cell gyroid matrix foam 270 creates a vertically aligned, puncture-anchored waste disposal method. This allows injectors to maintain clean and organized workspaces while minimizing risk of accidental needlestick injuries.

Sterile-Like Functionality: Although not sterile, the open cell gyroid matrix foam 270 mimics aspects of sharps disposal in its ability to securely retain used sharps, particularly in procedural or post-injection workflows. Its removable nature allows for modular replacement or cleaning as needed. That is, the open cell gyroid matrix foam 270 insert can be swapped out independently, enabling easy replacement if saturated or deformed, or if a different infill density or pattern is preferred for specific procedures or injector preferences. This supports ongoing evolution of the product ecosystem without redesigning the full tray structure.

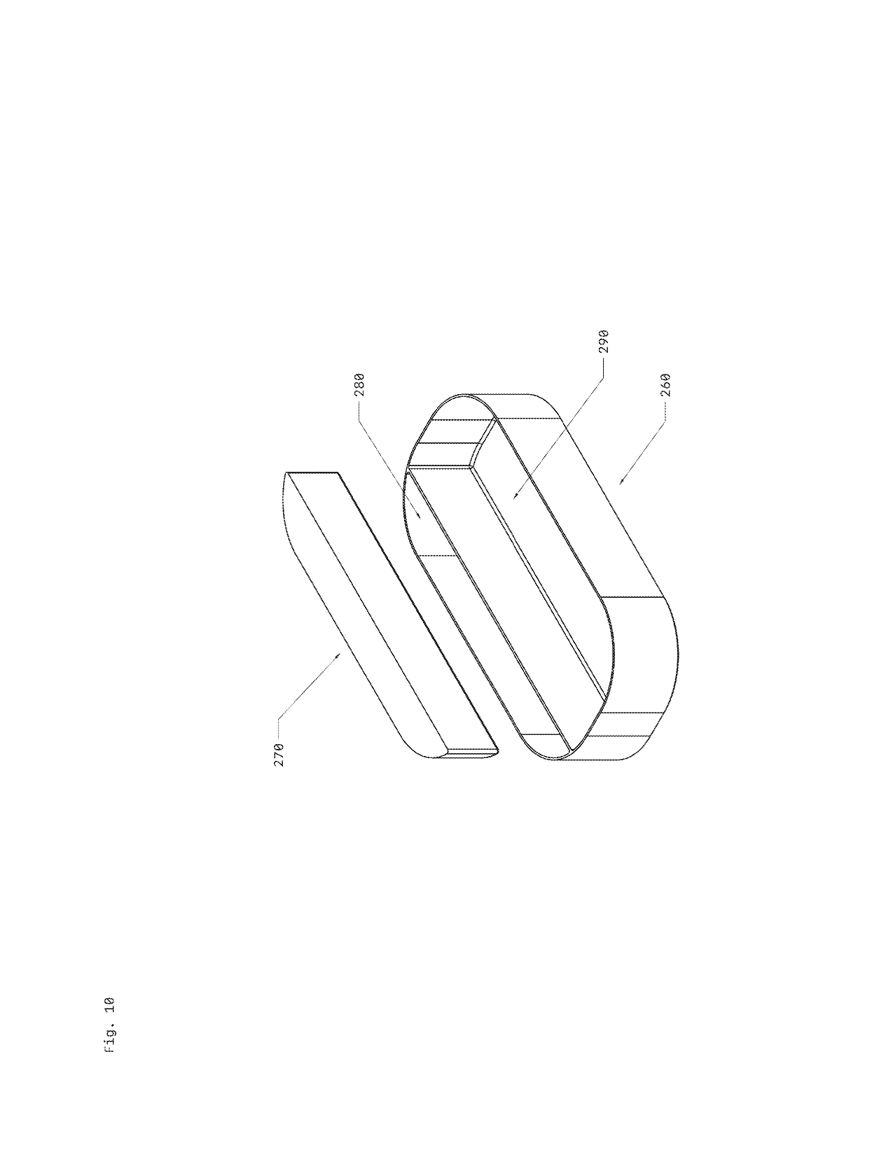

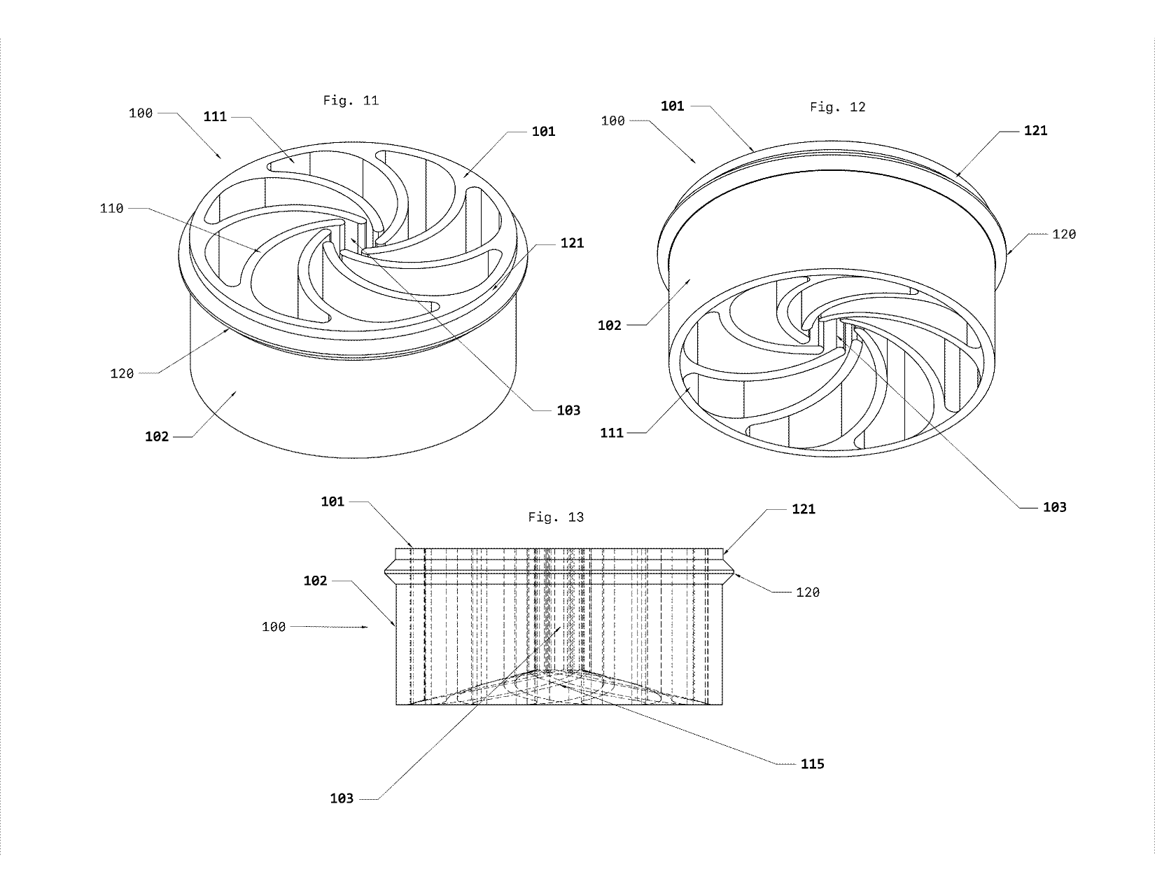

FIG. 11 shows isometric top view of the universal vial holder aperture 100. FIG. 11 is an enlarged view of the same universal vial holder aperture shown in FIG. 5.

FIG. 12 shows an isometric bottom view of the universal vial holder aperture 100. FIG. 12 is an enlarged view of the same universal vial holder aperture shown in FIG. 5 but from a bottom angle for increased clarification of the structure. As seen in FIG. 12, the fins 110 can be seen from both the top and bottom view of the universal vial holder aperture 100.

FIG. 13 shows a front view of the universal vial holder aperture 100 as if it were transparent. FIG. 13 illustrates the internal geometry of some embodiments. In some embodiments, the fins 110 form a cone of negative space 115 at the lower end of the universal vial holder aperture 100. This structure allows for displacement of fins 110 when a vial is inserted from the top of the universal vial holder aperture 100, i.e., on the side opposite where the fins 110 form the cone of negative space 115. In alternative embodiments, the cone of negative space 115 is posited in the upper portion of the universal vial holder aperture 100. In some embodiments, the cone of negative space 115 is posited in both the lower and upper portions of the universal vial holder aperture 100.

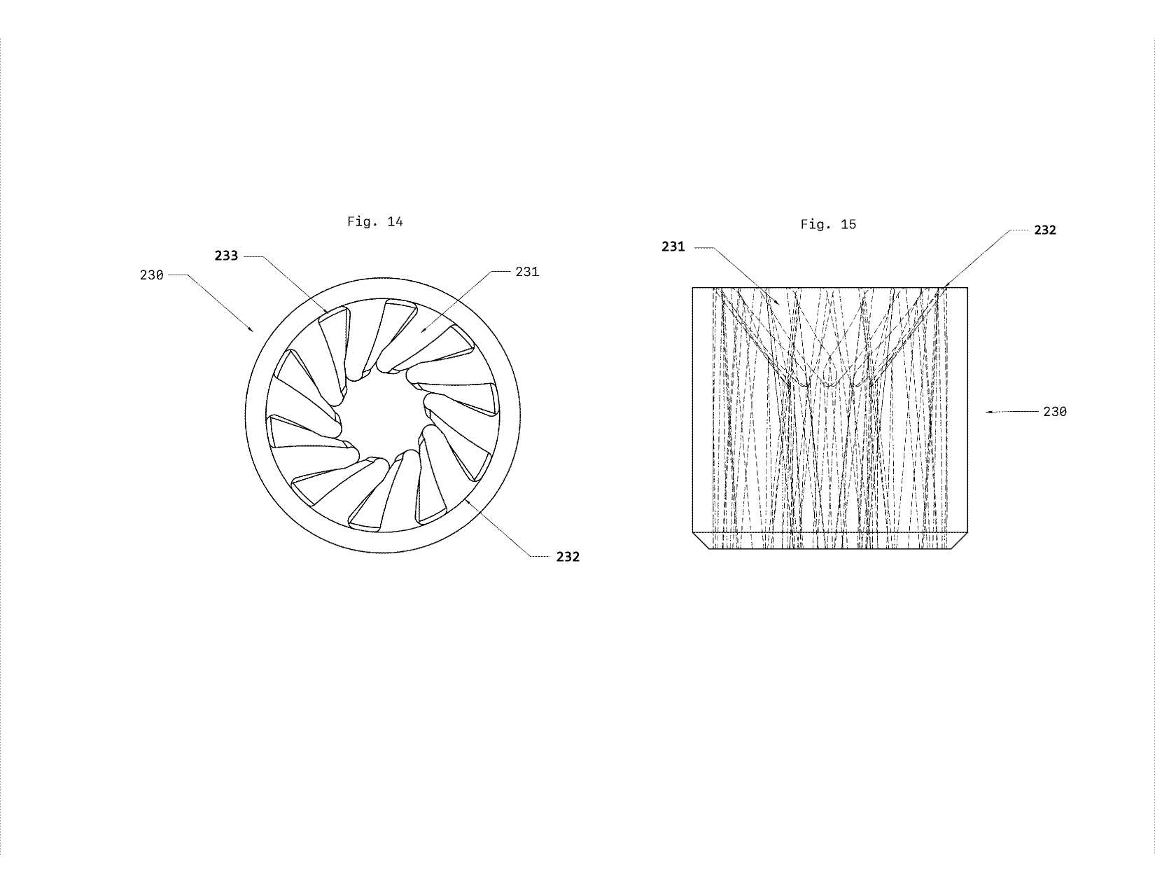

FIG. 14 shows a top view of the flexible holder insert 230 as seen in FIG. 7. The flexible holder insert 230 includes a generally cylindrical aperture 232 with straight, canted fins 231 extending inward from the interior wall 233.

FIG. 15 is front view of the flexible holder insert 230 as if it were transparent. FIG. 13 illustrates the internal geometry of some embodiments. In some embodiments, the fins 231 form the cone of negative space in the upper portion of the flexible holder insert 230. This structure allows for displacement of fins 231 when a vial is inserted from the top of the flexible holder insert 230. In alternative embodiments, the cone of negative space is posited in the lower portion of the flexible holder insert 230. In some embodiments, the cone of negative space is posited in both the lower and upper portions of the flexible holder insert 230.

As used herein, the term “about” and “approximately” have the typical meanings in the art, however in a particular example “about” and “approximately” can mean deviations of up to 10% of the values described herein.

Although the different examples are illustrated as having specific components, the examples of this disclosure are not limited to those particular combinations. It is possible to use some of the components or features from any of the embodiments in combination with features or components from any of the other embodiments.

The foregoing description shall be interpreted as illustrative and not in any limiting sense. A person of ordinary skill in the art would understand that certain modifications could come within the scope of this disclosure. For these reasons, the following claims should be studied to determine the true scope and content of this disclosure.

1. A universal vial holder aperture comprising:
a cylindrical body with an inner and outer wall wherein an inner area is defined by a perimeter formed by the inner wall of the cylindrical body and
a plurality of flexible fins,
wherein the plurality of flexible fins extends from the inner wall of the cylindrical body into the inner area.

2. The universal vial holder aperture of claim 1 wherein the plurality of flexible fins comprises from 4 to 12 fins.

3. The universal vial holder aperture of claim 1 wherein all of the plurality of flexible fins are uniformly canted in the same rotational direction.

4. The universal vial holder aperture of claim 3 wherein the plurality of flexible fins are shaped to form a cone of negative space positioned at at least one end of the cylindrical body.

5. The universal vial holder aperture of claim 1 additionally comprising a vial holder base body, said vial holder base body comprising:
a generally planar upper surface, surrounding perimeter walls, and a cylindrical cavity, wherein said cylindrical cavity receives said universal vial holder aperture.

6. The universal vial holder of claim 5 additionally comprising a treatment tray base,
wherein said treatment tray base comprises a small module compartment, a large module compartment, and at least one protruding portion positioned between said small module compartment, a large module compartment,
wherein the small module compartment and a large module compartment are physically separated by the at least one protruding portion of the treatment tray base, and
wherein the treatment tray base receives the vial holder base body in the small module compartment.

7. The universal vial holder of claim 6 additionally comprising a large module,
wherein the large module comprises at least one area for receiving at least one flexible holder insert and
wherein the treatment tray base receives the large module in the large module compartment.

8. The universal vial holder of claim 7 wherein the flexible holder insert comprises, a cylindrical body having a top portion and a bottom portion and having an inner and outer wall wherein an inner area is defined by a perimeter formed by the inner wall of the cylindrical body, and
a plurality of flexible fins,
wherein the plurality of flexible fins extends from the inner wall of the cylindrical body into the inner area.

9. The universal vial holder of claim 8 wherein the plurality of flexible fins of the flexible holder insert comprises from 6 to 18 fins.

10. The universal vial holder of claim 8 wherein the plurality of flexible fins of the flexible holder insert are straight and are canted to form a gentle corkscrew profile.

11. The universal vial holder of claim 8 wherein the plurality of flexible fins are shaped to form a cone of negative space positioned at at least one end of the cylindrical body.

12. The universal vial holder of claim 8 wherein the plurality of flexible fins of the flexible holder insert have a top portion and a bottom portion wherein the top portion of the plurality of flexible fins slant toward the bottom portion of the cylindrical body of the flexible holder insert collectively forming a frustoconical structure.

14. The universal vial holder of claim 7 wherein the large module comprises a plurality of areas for receiving a flexible holder insert.

15. The universal vial holder of claim 14 wherein the large module comprises a plurality of areas for receiving a capped needle.

16. The universal vial holder of claim 5 additionally comprising:
an undermining cavity extending laterally along the bottom of the cylindrical cavity wherein the undermining cavity is adapted to receive one or more segmented weights.

17. The universal vial holder of claim 16 wherein the segmented weights comprise a plurality of weights and at least one adhesive backing.

18. The universal vial holder of claim 17 wherein weights are positioned at the bottom of the undermining cavity and the at least one adhesive backing is positioned above the weights in the cavity.

19. The universal vial holder of claim 18 wherein a cover plate is positioned above the at least one adhesive backing in the cavity and separates the segmented weights from the vial holder aperture.

20. The universal vial holder of claim 6 wherein the treatment tray base additionally comprises
a disposable tray insert, wherein the disposable tray insert comprises and open cell gyroid matrix foam and an open compartment adapted to receive waste items.
